(19) United States
(12) Patent Application Publication
(10) Pub. No.: US 2026/0350092 A1
(43) Pub. Date: Nov. 5, 2026

(54) DEVICE FOR DATA EXCHANGE IN A SYSTEM, AND COMPUTER-IMPLEMENTED METHOD

(71) Applicant: Siemens Aktiengesellschaft, München (DE)

(72) Inventors: Veronika HADERLEIN-HØGBERG, München (DE); Steffen LAMPARTER, München (DE); Roland ECKL, Erlangen (DE); Johannes WEISS, Erlangen (DE)

(21) Appl. No.: 19/484,849

(22) PCT Filed: May 15, 2023
(86) PCT No.: PCT/EP2023/063005

§ 371 Date: Nov. 14, 2025

(51) Int. Cl. G06F 16/81; G05B 19/418

(52) U.S. Cl. CPC G06F 16/81; G05B 19/4186

(57) ABSTRACT

The invention relates to a common, agreed-upon domain model, a data model, and a protocol for providing out-of-the-box interoperability between different systems (e.g. including those from different manufacturers) within a shared context that is defined on the basis of a “knowledge requirement”. This enables more efficient integration between the products.

This application is the National Stage of International Application No. PCT/EP2023/063005, filed May 15, 2023. The entire contents of this document are hereby incorporated herein by reference.

### BACKGROUND

The present embodiments relate to a common, agreed domain model, a data model, and a protocol for providing out-of-the-box interoperability between different systems (e.g., also those from different manufacturers) within a shared context that is defined based on a knowledge requirement.

Today, both the shop floor and top floor environments are very heterogeneous, with many different protocols and standards for data disclosure and sharing. Data exchange is complicated not only by the large number of different interfaces, but also by the variety of information models and the semantic maturity of the data on which these interfaces are based: unstructured raw data without context relating to data, right down to various standards or proprietary data models that have been structured and enriched by an explicit ontology. Complexity, scope, and usage context vary in many ways.

Take the following example case: a customer wants to combine data in a cloud integration platform (e.g., EUB Software-as-a-Service offering in the context of the Internet of Things, which stores operational data and makes it accessible via digital applications) and an edge solution (e.g., an open, ready-to-use edge computing platform consisting of edge devices, edge apps, edge connectivity, and an application and device management infrastructure; a context that extends from the shopfloor level to the cloud).

This provides that data from industrial robots, for example, is to be able to move across the different layers to make the data available for analyses in a cloud solution.

Although the context and the underlying model (e.g., in this case, IoT assets) are very similar, there are a number of problems: the metamodels on which the different data models and standards are based, on which the data relating to the different robots is based in turn, differ in structure as well as in characteristics; APIs and other interfaces vary; both the cloud and edge platforms are “inwardly facing,” providing there are no established synchronization mechanisms with the respective other system.

It turns out that the two systems cannot be simply plugged together, and the integration effort and the costs for this would be very high.

There are other examples where, for example, a distributed control system (DCS) or supervisory control and data acquisition (SCADA) system is intended to be integrated with a manufacturing operations management (MOM) system, or the customer wants to integrate the data from multiple shopfloor sources so as to optimize the process; however, no established solution has been able to be provided here yet.

Today, there are many tools to create custom solutions that solve such integration problems. These solutions are often expensive, time-consuming, and non-reproducible because they each address individual, highly customized integration problems.

### PRIOR ART

EP 3084628 describes a method for integrated data processing in a plant constructed and operated by a variety of software applications with different functionalities, with steps for connecting these software applications via a communication frame and mechanism. A common data model, including data shared by at least two of these applications, is provided, and the shared data is managed.

Approaches to addressing the challenges described may be divided as follows: leave the data source “as it is” and integrate the data using the conventional procedure with the steps of extracting, transforming, loading; standardize the way in which software systems structure and name data and make it available, typically on a domain-by-domain basis (e.g., one standard per domain type). The standardization approach may also distinguish the extent to which the standardization works: whether the naming, meaning, and structure of data elements is prescribed and disclosed down to the smallest detail of a particular domain; or whether the enforcement of standardization is kept to a minimum (e.g., data standardization on a “need-to-know” basis, standardization of only the common context).

Various known approaches are described in more detail below.

Option A: Full-depth point-to-point data integration, 70.

Traditionally, there have been attempts to solve the above-described problems when integrating heterogeneous data by creating an additional layer of point-to-point data integration, with all the necessary connectors for extracting and transforming data from the various, individual data sources at any depth, or alternatively using virtualization.

However, an additional layer is not always desirable or useful from the customer's point of view (e.g., in cases where the customer only wants to exchange data bilaterally between two individual tools in a traditional one-to-one process).

In addition, the number of integration mechanisms increases with each data source that is added to the point-to-point integration. An integration layer also shifts the configuration effort to a solutions provider or leads to additional engineering effort on the customer side.

For Option A, there are already data integration tools and solutions on the market, such as: Cognite Data Fusion® Platform, https://www.cognite.com/en/; and Element Unify, https://www.elementanalytics.com/

FIG. 7 shows Option A, the interoperability of, for example, three systems 71, 72, 73 over a 1:1 integration layer 70. As shown from the illustration, three systems already require 6 connections 712, 721, .... Four systems already require 12 translation connections.

Option B: Comprehensive data standardization for each domain, 80.

Instead of traditional heavy-weight data integration under Option A, with all the costs associated with highly customized data integration, Option B standardizes the way in which data is structured, described, and made available from its source. Ideally, this results in interoperability (e.g., by design), and so it is easier to consume and exchange data via common APIs and serialization formats.

The advantage of this option is the full transparency and predictability of the data transmissions due to the standardization.

Possible ways to do this are either standardizing the underlying data models themselves or the data models remaining diverse, but referring to a common metamodel for data.

However, the existing standard landscape is fragmented and is not usually sufficient to fully solve a customer problem.

The standards may address only a specific area of interest and may not refer to a common metamodel, which makes translating the data models into each other a difficult task. In addition, in the case of new functions, the existing systems or standards will not cover the new aspects.

The manner in which and with what degree of detail a particular software system should describe, structure, and make its data available is also prescribed. This makes the system development process very inflexible and limits the range of design options available to a system architect in an unconstructive manner.

In addition, each introduction of a new standard intended to be compatible with the various software systems requires a separate translation effort for each of the systems.

For Option B, for example, the following standards, standardization approaches, and modeling languages are available in the prior art: Asset Administration Shell (AAS); OPC-UA Companion Standards; Siemens Ontology Library; Bosch Aspect Meta Model (BAMM); Microsoft DTDL; Web of things; and ISO 15926-14

Some of the standards, such as BAMM and AAS, focus on defining a common metamodel with a serialization format to exchange the description based on those metamodels in a standardized manner. In addition, these standards focus on selected domains, such as automation or device descriptions, and therefore cover only a portion of the desired solution space.

FIG. 8 illustrates an example of Option B. Each of the three systems 71, 72, 73 is compatible with each one of the standards 81, 82, 83 used (e.g., ISA-95, VDI 2770, or AAS). Each system includes its own local translation solution 84, 85, 86, heuristics 843, 842, 853, 852, 863, 862, ..., which contains instructions for translating its own standard 81 (or 82, 83) into the other standards 82, 83 (or 81).

In this case, too, the number of required heuristics increases sharply with the number of underlying systems.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, a method that solves the described problems of the integration of systems and enables data exchange between different systems (e.g., each including one or more processors) in a plant is provided.

A data standardization approach that operates on a “need-to-know” basis with a focus on a common context is provided.

The approach of the present embodiments is used to overcome the weaknesses of Options A and B described above while making use of their respective strengths.

By adding an “anchoring mechanism” to existing, fully independent systems (e.g., to a robot and to a machine tool in a machine loading scenario), a basic form of interoperability is enabled that allows the systems to exchange a predefined set of information (e.g., material IDs that a robot is intended to supply to the machine tool).

The purpose of the proposed model is to provide a common, agreed domain model, a data model, and a protocol for providing out-of-the-box interoperability between different systems (e.g., also those from different manufacturers) within a shared context that is defined based on a “knowledge requirement.” This enables more efficient integration between the products.

For example, such systems may be different software products, different assets, or any combination of both.

The subject matter of the application, as well as other embodiments, are also explained below by the figures.

### BRIEF DESCRIPTION OF THE DRAWINGS

FIG. 1 shows a schematic illustration of a model;

FIG. 2 shows a multilayer anchor model;

FIG. 3 shows type level engineering;

FIG. 4 shows instance level engineering;

FIG. 5 shows an example scenario;

FIG. 6 shows a comparison with the prior art;

FIG. 7 shows the prior art, Option A, integration layer; and

FIG. 8 shows the prior art, Option B, with standardization.

### DETAILED DESCRIPTION

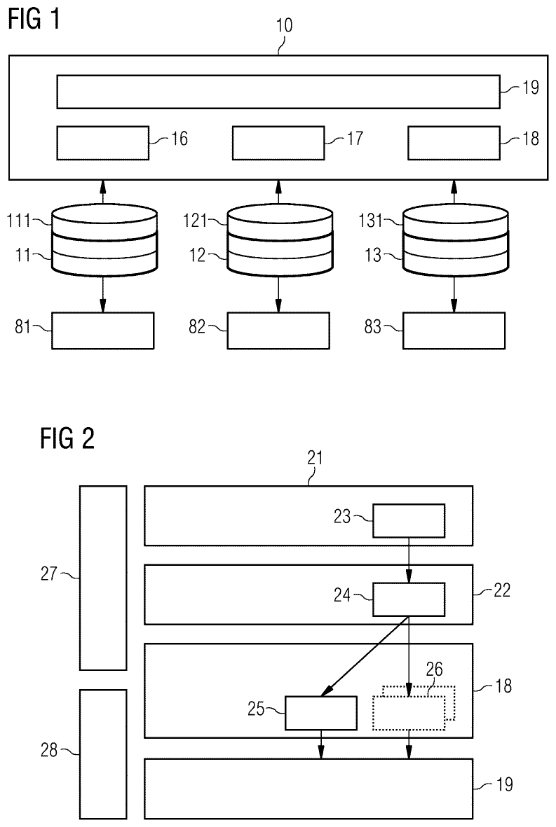

FIG. 1 illustrates an embodiment, with three systems 11, 12, 13 illustrated, these being compatible with different standards 81, 82, 83 (e.g., ISA95, VDI2770, and AA8). Each of the systems 11, 12, 13 includes an anchor advanced domain (AAD) model with a specific focus (e.g., on the plant hierarchy, 111, product data, 121, or the CO2 footprint of the product, 131).

If systems may collaborate with a common model supported by all participating applications, these applications do not need to be manually integrated 1:1 (see Scenario A described above), but are able to collaborate and exchange data in a more automated and more seamless manner, minimize redundant engineering effort, and avoid system-wide inconsistencies. At the same time, there is no need for each of the systems involved to be able to understand the other (e.g., system data in all domain details), but only on a “need-to-know” basis that is aligned with a common context.

The term “anchor” also used in the following text refers to the concept, 10, that participating systems (e.g., products) do not need to have a common “world model” with the intention of defining every detail in this large model and thus having to take into account all the requirements of all products in all the details of the model.

Instead, a mandatory set of basic building blocks is specified at the metamodel level, 19, which enables applications to create their own objects therefrom. However, because these objects are modeled with a minimum set of common entities, attributes, and relationships, applications may see these objects as “secure anchors” between them and other systems.

These “anchors” enable collaboration by identifying and using basic objects of the anchor model. It is also possible to use information outside the scope of the anchor model, using external references that link semantic models, ontologies, and taxonomies in applications that are able to follow these references.

The specification provides a common metamodel (e.g., the anchor core model) 19 and, building on this, very simple anchor domain models, 18 (e.g., assets, process objects, etc.) that may be extended to define advanced domain models.

Definition of anchor registry, 16, keeps track of all available assets and where to find them, may translate between different IDs of the assets in the different domains (e.g., system-specific, external, unique, etc.), creates a unique namespace, optionally in combination with a central broker (e.g., managing topologies and data streams), and a distributed approach without a register is conceivable as an option.

Definition of type repository, 17:
tracks all defined anchor types and their history;
enables central sharing and searching of type definitions without having to redefine types within each system;
may be pre-populated with known types or known information models; and is expandable by all.

Definition of anchor domain models, 18
Each anchor domain 18 has a generic interface API for interacting with the anchor model, but has no way to define methods and events for custom types of entities. Its main purpose is to provide, describe, and manipulate data without losing the semantics. It does not allow the definition of operations for interacting with custom objects (e.g., calibrating a robot or starting a machine).

The anchor model has extension mechanisms that enable the anchor model to be linked to external models, instances, and even interfaces.

FIG. 2 shows in more detail how these different artifacts are linked to one another.

The basis is again the anchor core model, 19, a metamodel with a toolbox for creating all kinds of models, for defining rules and possibilities. This model is kept as small as possible to minimize complexity.

Building on this, the anchor domain models, 18, are also very slim models that cover the needs of the different domains as to how data is handled, in terms of organization, storage, exchange, and interaction. Multiple domain models 18 may also be supported in parallel. A distinction may be made, for example, between an asset anchor model, 25, and one or more process anchor models, 26.

A layer referred to as an advanced domain model (AAD), 22, is located above it.

These models relate to specific products and may also include and combine elements of different domain models, 18. For example, the ISA-88 anchor model, 24, is included. Last, there is another layer of custom models, 21 that are created and maintained for specific customer requirements, 23.

Data interfaces are either product-specific 27, or general in nature, 28.

Products may enrich APIs with product-specific functions, such as advanced queries. These are then not supported or used by other products.

Instead of creating only one model for linking different standards to different models and serialization formats, it is provided to stay within the same metamodel so as to have the same rules for identifying, structuring, and relating across all categories and external references.

The data exchange between two individual systems is permitted on this basis. This applies, for example, to interoperability.

Collaboration and exchanging of data across multiple systems in a common model is offered. This enables systems to contribute to this model and/or enrich the model with additional information.

There are two different, situation-dependent approaches to the application:
During engineering:

Methods for configuration and commissioning (e.g., anchoring a connection between two different data systems).
During runtime:

New incoming data is automatically transformed between systems.

The following provides additional information and example embodiments relating to the proposed solution.

A method for configuration and commissioning (e.g., “anchoring”) a connection between two different data systems is provided.

To build such a multilayered model, an engineering process is provided that enables data to be anchored consistently across distributed systems at both the type and instance levels.

Two roles are introduced for coordination between the different systems: a first register, the “anchor type repository,” 30, and a second register, the “anchor registry,” 16.

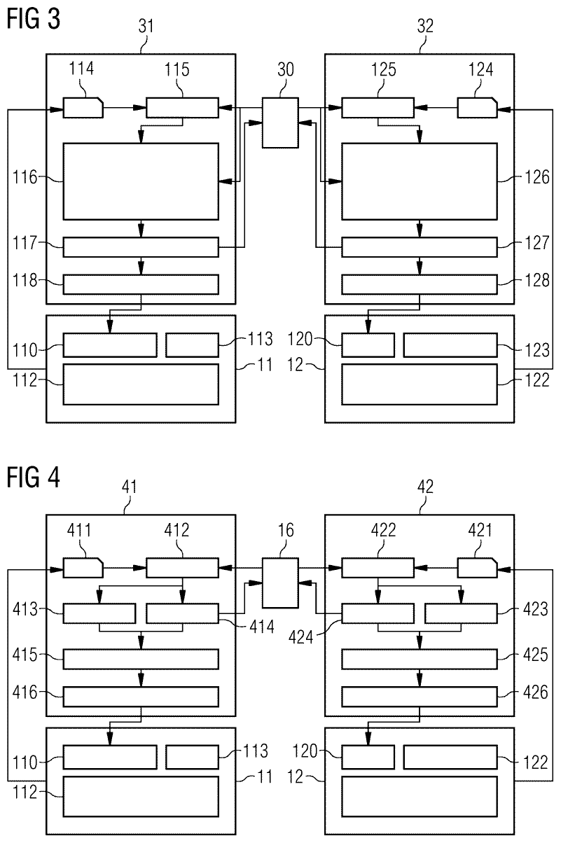

The roles may be taken on by one of the systems (e.g., integrated) or by an independent third party system. The roles are described based on FIG. 3 and FIG. 4.

Anchor construction is carried out on two levels:
A) Engineering at type level (e.g., as illustrated in FIG. 3), based on data models of the respective system, 114, 124, includes the following steps.
1. Identify the relevant anchor domains (e.g., equipment, capabilities, order, location) based on the System A data model, 114, 124, and identify the available basic types intended to be used (e.g., provided or retrieved). Basic models may be retrieved from the anchor type repository, 30.

Adding additional basic types is not permitted.
2. Select additional types from potentially available advanced domain models, 115, 125, and those already created from custom models, 116, 126 (e.g., see also FIG. 2). Advanced and custom models may be retrieved from the anchor type repository, 30.
3. If additional domain objects with well-defined semantics that do not yet exist as types in advanced or custom models are to be exchanged, the creation of new types may be initiated via the anchor type registry, 117, 127.

The anchor type repository provides consistency through a data governance process that depends on the organizational setup, business scenario, etc., and is therefore not explained in detail here.
4. Based on the defined anchor type models, the API may be derived and provided as an additional, standardized API interface to System A. 118, 128.

For additional systems B ... Z, the engineering process is repeated at type level. Advancements to the advanced and custom models triggered by one system may lead to reimplementation of the other systems.

Therefore, all advancements are to be carefully regulated, as mentioned in step 3 above.

B) Engineering at instance level (e.g., illustrated in FIG. 4) includes the following steps:
1. Entity search: Retrieving existing entities from the local system and matching the entities with the entities in the anchor registry, 16, based on IDs and mandatory attributes/relationships for the corresponding type.

Depending on the anchor registry, different forms of entity matching and deduplication algorithms may be used (e.g., identification and elimination of redundant data).
2. If the entity already exists in the anchor registry, the available entity definition is downloaded (e.g., all available relationships, attributes, references) and is compared to the local entity, 412. In the event of differences, a predefined merge routine is applied (e.g., overwriting of local definitions). Local data structures cannot be easily changed, so this scenario typically results in local mapping procedures that enable local instances to be transformed into anchor-compliant instances, 413.

If the entity does not exist in the anchor registry, a new anchor entity is registered, 414, through a registry API.
3. The entity description may optionally be extended to include additional relations, attributes, or references that are designed to lead to additional mappings.
4. All mappings developed in steps 2 and 3 are to be run at runtime when data is read or written via the anchor interface. Therefore, the mapping logic is to be implemented and distributed as part of the anchor interface.

There are several ways to illustrate and execute mappings. For example, identifiers may be easily mapped through a mapping table that assigns an anchor ID to each internal entity ID. In most cases, however, more complicated maps, including data structure transformations, are to be provided.

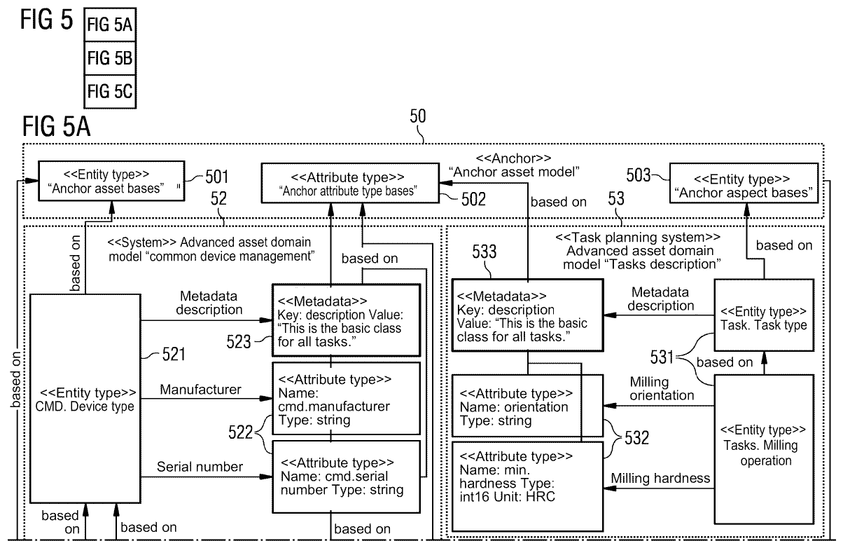

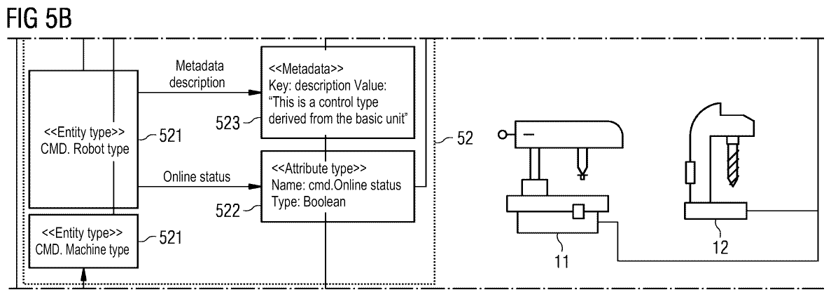

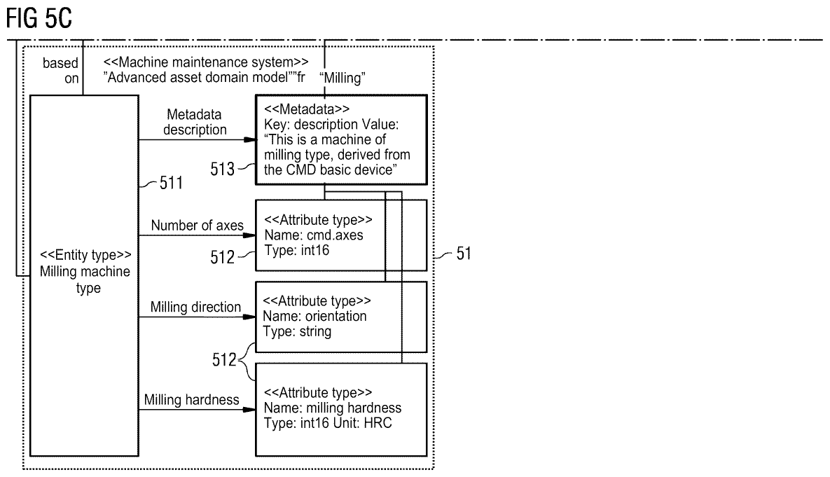

FIG. 5 illustrates an example embodiment.

The following text describes an example situation in which robots from different manufacturers are to be able to match tasks from a task management system with the correct milling machines 11, 12, depending on the requirements for the milling machine: alignment and hardness of the available milling cutters. Only the type of information that is (e.g., must be) shared in this particular area is expressed as an anchor (need-to-know): special features for a milling task, but not for other types of tasks; specific characteristics of milling machines that are relevant to milling, but not for other types of tasks such as maintenance of a milling machine or onboarding.

A first domain model “Milling” 51 in the “Maintenance” area contains information about the device 511 (e.g., the number of axes or the orientation and the degree of hardness of the milling attachments, 512). Another description 513 is included, which refers to other asset domain models (e.g., to “common device management” 52). This includes data relating to the device type 521 (e.g., description, manufacturer, serial number, 522), the robot type 521 (e.g., description, online status 522), and the machine type. Another description 523 is also possible here.

The next piece of information refers to the task planning 53, which contains, for example, information 531 about the minimum required degree of hardness or the necessary orientation of the tool, 532.

The challenge, for example, is to enable automated task matching with any number of robots and milling machines, each from a different manufacturer, and therefore equipped with different manufacturer-specific interfaces, data structures, and protocols. There is currently no industry standard that defines a jointly agreed data model and consistent ID identifiers.

The steps described above may be used to add an additional interface to such systems that enables them to exchange task and capability information in a standardized manner without having to replace the existing data modeling approach and interface. In addition, other systems C ... Z may also integrate with the same anchor mechanism.

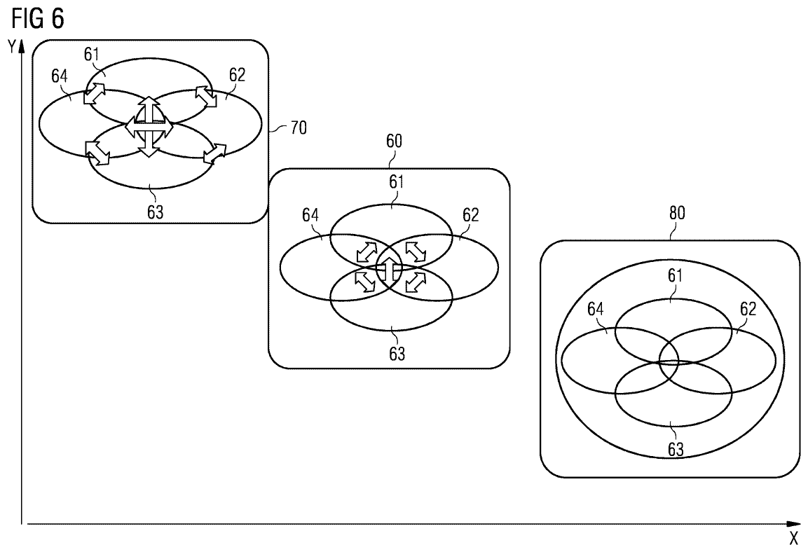

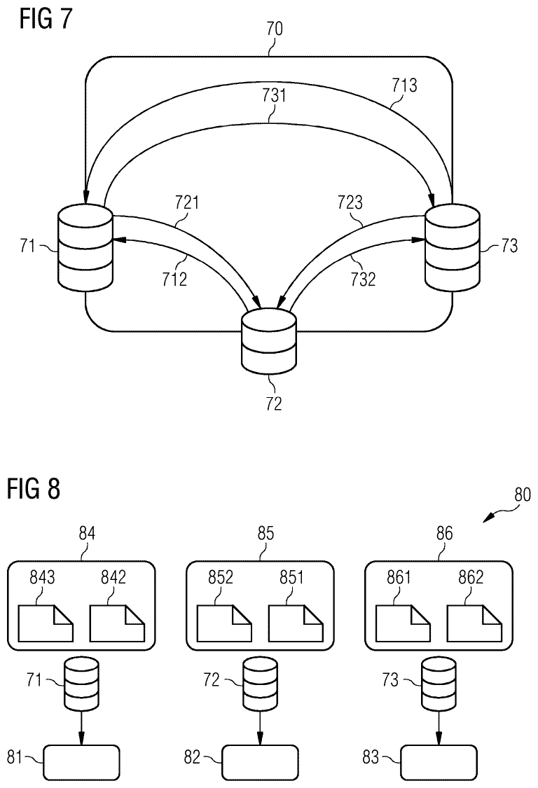

Unlike traditional data integration approaches that require a fully integrated data model, the focus of the approach described above is on the common context for the exchange of data between two or more collaborative systems. The modeling focus is limited to a few essential elements (e.g., only those that are relevant to the common context (need-to-know)). The anchor model also specifies an agreed vocabulary for describing these elements. The anchor model approach described aims to balance the need for system-specific freedom, to use “deep” domain-specific data models without having to adhere in every detail to a common, fully integrated set of data, and model and to avoid the need for 1:1 integration efforts between individual systems. FIG. 6 illustrates the described concept 60 in comparison with the concepts of Option A, 70, and Option B, 80, explained as part of the prior art. The basis for this is respective existing data from systems A ... D, 61, 62, 63, 64.

Unlike other modeling or standardization approaches, the anchor model offers two options that are combined. First, organizations may model any domain and any semantics using the anchor model. Second, existing and external representations (e.g., based on OPC-UA, ECLASS, AAS, etc.) may be linked together without actually having to be dragged into the new model itself.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications may be made to the described embodiments. It is therefore intended that the foregoing description be regarded as illustrative rather than limiting, and that it be understood that all equivalents and/or combinations of embodiments are intended to be included in this description.

1. A device for data exchange in a plant, using production domains, the device being configured for the production or processing of at least one product, wherein the plant consists of plant components that are intended to communicate with each other, the device comprising:
a metamodel with basic rules for the data exchange that are valid for all production domains;
at least one domain model relating to a task to be processed, and a distinctive feature, and a domain model limited to properties of a plant component of the plant components that are relevant to the task to be processed, with rules for a domain category, each with corresponding rules regarding organization and exchange of data within the respective domain;
at least one advanced domain model with rules for the exchange of data required for the product manufactured in the plant; and
at least one manufacturer-specific model configured to specify the data exchange based on the at least one advanced domain model of a plant component.,

2. The device of claim 1, wherein the metamodel contains the following definitions:
entities;
attributes;
relationships between the entities; and
references from each of the entities, attributes, and relationships to an external domain model.

3. The device of claim 1, wherein the at least one domain model comprises data models for:
hierarchy of the plant components; product;
energy balance;
production process;
events in the plant;
capabilities of the plant component;
location; or
any combination thereof.

4. The device of claim 1, wherein the advanced domain model uses standardized data structures or modeling languages, the standardized data structures or modeling languages including:
Asset Administration Shell (AAS);
OPC-UA Companion Standards;
Siemens Ontology Library;
Bosch Aspect Meta Model (BAMM);
Microsoft DTDL;
Web of things;
ISO 15926-14;
VDI 2770;
ISA-95; or
any combination thereof.

5. The device of claim 1, wherein the metamodel is connected to:
a register for storing and managing information relating to basic building blocks of all plant components at the metamodel level, as well as associated identifiers in the respective associated domain; and
a type of repository for saving defined types and history, for central sharing and searching of type definitions without having to redefine types within each system.

6. The device of claim 1, further comprising a device for graphically representing information exchanged, for asset managers, or for checking conformity of the information.

7. A computer-implemented method for data exchange by domains in a plant using production, the computer-implemented method being configured for the production or processing of at least one product, wherein the plant includes plant components, wherein a plant component of the plant components comprises software components that are intended to communicate with each other, the computer-implemented method comprising:
specifying, using at least one manufacturer-specific model, the data exchange, the at least one manufacturer-specific model being based on an advanced domain model that requires rules for the exchange of data required for the product manufactured in the plant, and uses:
uses at least one domain model relating to a task to be processed, and a distinctive feature, and a domain model limited to properties of the plant component that are relevant to the task to be processed, with rules for a domain category, each with own rules regarding organization and exchange of data in the domain which is based on; and
a metamodel with basic rules for the data exchange that are valid for all production domains.

8. The computer-implemented method of claim 7, wherein the metamodel contains definitions, the definitions comprising:
attributes;
relationships between the attributes; and
references from the attributes to the domain model.

9. The computer-implemented method of claim 7, wherein the domain model includes data models relating to:
hierarchy of the plant components;
product;
energy balance;
production process;
events in the plant;
capabilities of the plant component;
location; or
any combination thereof.

10. The computer-implemented method of claim 7, wherein the advanced domain model uses standardized data structures or modeling languages, the standardized data structures or modeling language including:
Asset Administration Shell (AAS);
OPC-UA Companion Standards;
Siemens Ontology Library;
Bosch Aspect Meta Model (BAMM);
Microsoft DTDL;
Web of things;
ISO 15926-14;
VDI 2770;
ISA-95; or
any combination thereof.

11. The computer-implemented method of claim 7, wherein a graphical representation of the information exchanged is including for asset managers or for checking conformity of the information.

12. The computer-implemented method of claim 7, further comprising extending the system in systems engineering at type level, the extending comprising:
identifying the relevant domains from the metamodel;
adding associated manufacturer-specific domains;
ascertaining missing domains and creating new domain objects in a register;
providing an interface.

13. The computer-implemented method of claim 7, further comprising extending the system in systems engineering at instance level, the extending comprising:
identifying existing entities of the extension;
comparing with contents of a register and when a result is positive, using a definition of the entity found in the register or, when the result is negative, registering a new entity in the register; and
extending an entity description by additional necessary information.

14. (canceled)

15. In a non-transitory computer-readable storage medium that stores instructions executable by one or more processors of a device for data exchange in a plant, using production domains, the device being configured for production or processing of at least one product, wherein the plant consists of plant components that are intended to communicate with each other, the device comprising:
a metamodel with basic rules for the data exchange that are valid for all production domains;
at least one domain model relating to a task to be processed, and a distinctive feature, and a domain model limited to properties of a plant component of the plant components that are relevant to the task to be processed, with rules for a domain category, each with corresponding rules regarding organization and exchange of data within the respective domain;
at least one advanced domain model with rules for the exchange of data required for the product manufactured in the plant; and
at least one manufacturer-specific model configured to specify the data exchange based on the at least one advanced domain model of a plant component.
